(19) United States
(12) Patent Application Publication
(10) Pub. No.: US 2006/0038759 A1
(43) Pub. Date: Feb. 23, 2006

(54) Liquid crystal display and driving method thereof

(75) Inventors: Sunkwang Hong, Gyeonggi-do (KR); Sang-Soo Kim, Seoul (KR); Jong-Hyon Park, Seoul (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/197,464

(22) Filed: Aug. 3, 2005

(30) Foreign Application Priority Data
Aug. 20, 2004 (KR) 10-2004-0065842

(51) Int. Cl. G09G 3/36

(52) U.S. Cl. 345/87

(57) ABSTRACT

A liquid crystal display is provided, which includes a plurality of pixels; a signal controller outputting externally applied input image data or impulsive data as output image data, based on the input image data; and a data driver applying data voltages corresponding to the output image data from the signal controller to the pixels, wherein a frame frequency of a frame of the input image data is different from a frame frequency of a frame of the output image data.

### BACKGROUND OF THE INVENTION

(a) Field of the Invention

The present invention relates to a liquid crystal display and a driving method thereof.

(b) Description of Related Art

A liquid crystal display (LCD) includes a pair of panels provided with field generating electrodes and a liquid crystal (LC) layer having dielectric anisotropy, which is disposed between the two panels. The field generating electrodes generally include a plurality of pixel electrodes arranged in a matrix and connected to switching elements such as thin film transistors (TFTs) to be supplied with data voltages at every row, and a common electrode covering an entire surface of a panel and supplied with a common voltage. A pair of field generating electrodes that generate the electric field in cooperation with each other and liquid crystal disposed therebetween form a so-called liquid crystal capacitor that is a basic element of a pixel along with a switching element.

The LCD applies the voltages to the field generating electrodes to generate an electric field to the liquid crystal layer, and the strength of the electric field can be controlled by adjusting the voltage across the liquid crystal capacitor. Since the electric field determines the orientations of liquid crystal molecules and the molecular orientations determine the transmittance of light passing through the liquid crystal layer, the light transmittance is adjusted by controlling the applied voltages, thereby obtaining the desired images.

In order to prevent image deterioration due to long-term application of the unidirectional electric field, etc., polarity of the data voltages with respect to the common voltage is reversed every frame, every row, or every pixel.

The polarity inversion of the data voltages increases the charging time of the liquid crystal capacitor since the response time of the liquid crystal is not particularly fast. Therefore, it takes a long time for the liquid crystal capacitor to reach a target luminance (or target voltage) such that an image displayed by the LCD is unclear and blurred.

In order to solve this problem, impulse driving that inserts a black image for a short time between normal images has been developed.

The impulsive driving technique includes an impulsive emission type of driving that periodically lights a backlight lamp to yield black images, and a cyclic resetting type of driving that periodically applies a black data voltage to the pixels to make them become a black state between the applications of normal data voltages.

However, these techniques do not compensate the large response time of the liquid crystal, and the response time of the backlight lamp is also large. Therefore, afterimages and flickering are generated to deteriorate the image quality. In addition, the cyclic resetting type of driving may decrease the time for applying normal data voltages for displaying normal images such that the liquid crystal capacitors do not reach a target luminance, and may decrease the total luminance of a screen due to the periodical black data voltage application.

### SUMMARY OF THE INVENTION

A motivation of the present invention is to solve the problems of conventional techniques.

In a embodiment of the present invention, a liquid crystal display (LCD) is provided, which includes: a plurality of pixels; a signal controller outputting externally applied input image data or impulsive data as output image data, based on the input image data; and a data driver applying data voltages corresponding to the output image data from the signal controller to the pixels, wherein a frame frequency (referred to as “an input frame frequency”) of a frame (referred to as “an input frame”) of the input image data is different from a frame frequency (referred to as “an output frame frequency”) of a frame (referred to as “an output frame”) of the output image data.

The output frame may include a normal frame and an additional frame, the output image data for the normal frame may be equal to the input image data, and the output image data for the additional frame may be equal to one of the input image data and the impulsive data.

The input image data may include first and second frame data, and the signal controller may output the impulsive data when a difference between the first frame data and the second frame data exceeds a predetermined value and outputs the first frame data when the difference does not exceed the predetermined value.

A frequency ratio of the input frame and the output frame may be 2:3.

The output frame may include three successive output frames, and the three output frames comprise two normal frames and one additional frame.

A frequency ratio of the input frame and the output frame may be 1:2.

The output frame may include two successive output frames, and the two output frames comprise one normal frame and one additional frame.

The frequency of the input frame may be 60 Hz.

The impulsive data may have grays that are smaller than a predetermined gray.

The impulsive data may be data for black.

The signal controller may include first and second memories for storing the first and second frame data, respectively.

The signal controller may write data for two pixel rows into the first and second frame memories and read data for three pixel rows from the first and second frame memories, for two horizontal periods.

The signal controller may write data for two pixel rows into the first and second frame memories and read data for four pixel rows from the first and second frame memories, for two horizontal periods.

The first and second frame memories may be DDR (double data rate) RAMs (random access memory).

In a further embodiment of the present invention, a driving method of a liquid crystal display including a plurality of pixels is provided, which includes: outputting input image data or impulsive data as output image data, based on the input image data; and applying data voltages corresponding to the output image data to the pixels, wherein a frame frequency (referred to as “an input frame frequency”) of a frame (referred to as “an input frame”) of the input image data is different from a frame frequency (referred to as “an output frame frequency”) of a frame (referred to as “an output frame”) of the output image data.

The output frame may include a normal frame and an additional frame, the output image data for the normal frame is equal to the input image data, and the output image data for the additional frame is equal to one of the input image data and the impulsive data.

The input image data may include first and second frame data, and the outputting of the input image data or the impulsive data comprises; calculating the difference between the first frame data and the second frame data; comparing the difference with a predetermined value; and outputting the impulsive data as the input image data when the difference exceeds the predetermined value and outputting the first frame data as the input image data when the difference does not exceed the predetermined value.

The impulsive data may have grays of smaller than a predetermined gray.

A frequency ratio of the input frame and the output frame may be one of 2:3 and 1:2.

The frequency of the input frame may be 60 Hz.

### BRIEF DESCRIPTION OF THE DRAWINGS

The present invention will become more apparent by describing embodiments thereof in detail with reference to the accompanying drawings, in which:

FIG. 1 is a block diagram of an LCD according to an embodiment of the present invention;

FIG. 2 is an equivalent circuit diagram of a pixel of an LCD according to an embodiment of the present invention;

FIG. 3 is a flow chart illustrating a method for generating output image data of an additional frame in an LCD according to an embodiment of the present invention;

FIG. 4 is a block diagram of a signal controller of an LCD according to an embodiment of the present invention;

FIG. 5 is a timing diagram of an input frame and an output frame when the frequency ratio thereof is 2:3 in an LCD according to an embodiment of the present invention;

FIG. 6 is a timing diagram representing input image data and output image data by a frame unit when the frequency ratio thereof is 2:3 in an LCD according to an embodiment of the present invention;

FIG. 7 is a timing diagram representing the input image data and the output image data shown in FIG. 6 by a pixel row unit;

FIG. 8 is a timing diagram of an input frame and an output frame when the frequency ratio thereof is 2:3 in an LCD according to an embodiment of the present invention;

FIG. 9 is a timing diagram of an input frame and an output frame by a frame unit when the frequency ratio thereof is 1:2 in an LCD according to an embodiment of the present invention; and

FIG. 10 is a timing diagram representing the input image data and the output image data shown in FIG. 9 by a pixel row unit.

### DETAILED DESCRIPTION OF THE PREFERRED EMBODIMENTS

The present invention will be described more fully hereinafter with reference to the accompanying drawings, in which preferred embodiments of the invention are shown.

In the drawings, the thickness of layers and regions are exaggerated for clarity. Like numerals refer to like elements throughout. It will be understood that when an element such as a layer, region, or substrate is referred to as being “on” another element, it can be directly on the other element or intervening elements may also be present. In contrast, when an element is referred to as being “directly on” another element, there are no intervening elements present.

Liquid crystal displays and driving methods thereof according to embodiments of the present invention will be described with reference to the accompanying drawings.

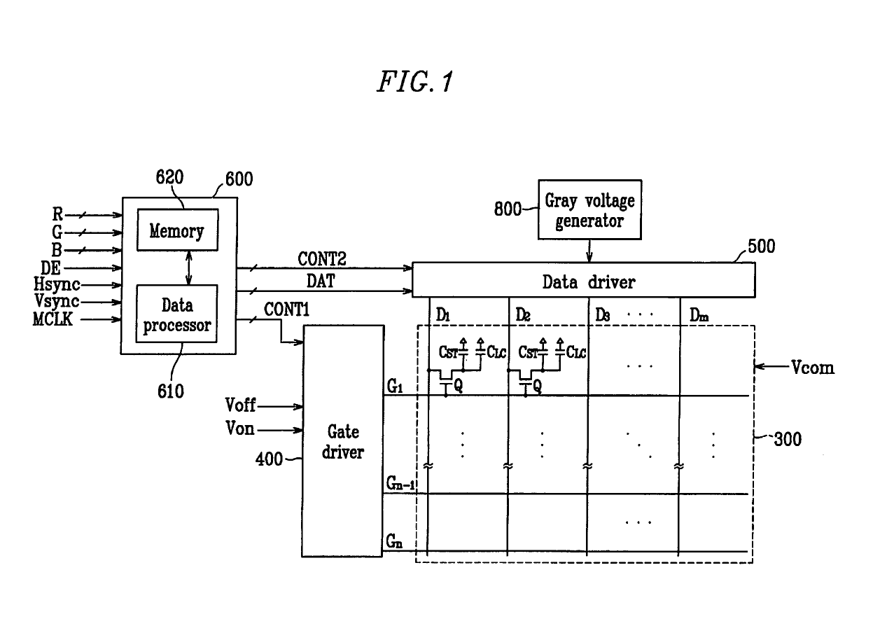

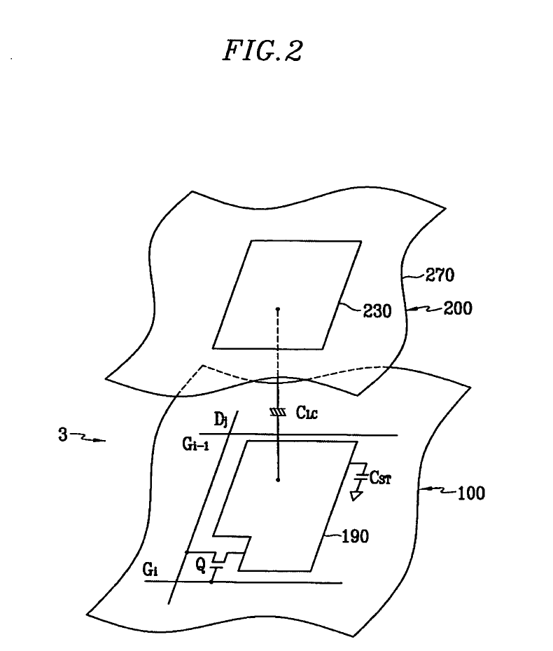

A liquid crystal display according to an embodiment of the present invention is now described in detail with reference to FIGS. 1 and 2.

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator 800 connected to the data driver 500, and a signal controller 600 controlling the above elements.

Referring to FIG. 1, the panel assembly 300 includes a plurality of display signal lines G₁-Gₙ and D₁-Dₘ and a plurality of pixels connected thereto and arranged substantially in a matrix. In a structural view shown in FIG. 2, the panel assembly 300 includes lower and upper panels 100 and 200 and an LC layer 3 interposed therebetween.

The display signal lines G1-Gn and D1-Dm are disposed on the lower panel 100, and include a plurality of gate lines G1-Gn transmitting gate signals (also referred to as “scanning signals”) and a plurality of data lines D1-Dm transmitting data signals. The gate lines G1-Gn extend substantially in a row direction and are substantially parallel to each other, while the data lines D1-Dm extend substantially in a column direction and are substantially parallel to each other.

Each pixel includes a switching element Q connected to the display signal lines G1-Gn and D1-Dm, and an LC capacitor C_{LC} and a storage capacitor C_{ST} that are connected to the switching element Q. The storage capacitor C_{ST} is optional and may be omitted in other embodiments.

The switching element Q that may be implemented as a TFT is disposed on the lower panel 100. The switching element Q has three terminals: a control terminal connected to one of the gate lines G1-Gn; an input terminal connected to one of the data lines D1-Dm; and an output terminal connected to the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as a dielectric of the LC capacitor C_{LC}. The pixel electrode 190 is connected to the switching element Q, and the common electrode 270 is supplied with a common voltage Vcom and covers an entire surface of the upper panel 200. In other embodiments, the common electrode 270 may be provided on the lower panel 100, and both electrodes 190 and 270 may have shapes of bars or stripes.

The storage capacitor C_{ST} is an auxiliary capacitor for the LC capacitor C_{LC}. The storage capacitor C_{ST} includes the pixel electrode 190 and a separate signal line, which is provided on the lower panel 100, it overlaps the pixel electrode 190 via an insulator, and is supplied with a predetermined voltage such as the common voltage Vcom. Alternatively, the storage capacitor CST includes the pixel electrode 190 and an adjacent gate line called a previous gate line, which overlaps the pixel electrode 190 via an insulator.

For color display, each pixel uniquely represents one of primary colors (i.e., spatial division) or each pixel sequentially represents the primary colors in turn (i.e., temporal division) such that a spatial or temporal sum of the primary colors is recognized as a desired color. An example of a set of the primary colors includes red, green, and blue colors, and optionally white (or a transparency). Another example of a set of the primary colors includes cyan, magenta, and yellow, which can be employed with or without red, green, and blue colors. FIG. 2 shows an example of the spatial division in which each pixel includes a color filter 230 representing one of the primary colors in an area of the upper panel 200 facing the pixel electrode 190. Alternatively, the color filter 230 is provided on or under the pixel electrode 190 on the lower panel 100.

One or more polarizers (not shown) are attached to at least one of the panels 100 and 200.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is connected to the gate lines G₁-Gₙ of the panel assembly 300, and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The gate driver 400 or the data driver 500 may be implemented as an integrated circuit (IC) chip mounted on the panel assembly 300 or on a flexible printed circuit (FPC) film in a tape carrier package (TCP), which is attached to the LC panel assembly 300. Alternately, the drivers 400 and 500 may be integrated into the panel assembly 300 along with the display signal lines G₁-Gₙ and D₁-Dₘ and the TFT switching elements Q.

The signal controller 600 includes a data processor 610 and a memory 620 and controls the gate driver 400 and the gate driver 500. The data processor 610 stores externally applied input image data R, G, and B into the memory 620 and generates output image data DAT based on the input image data R, G, and B.

Now, the operation of the above-described LCD will be described in detail.

Referring to FIG. 1, the signal controller 600 is supplied with input image data R, G, and B and input control data controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and processing the image data R, G, and B to be suitable for the operation of the panel assembly 300 on the basis of the input control data and the input image data R, G, and B, the signal controller 600 provides the gate control signals CONT1 for the gate driver 400, the processed image data DAT as output image data, and the data control signals CONT2 for the data driver 500.

At this time, a frame frequency of the input image data R, G, and B (referred to as “an input frame frequency”) is different from a frame frequency of the output image data DAT (referred to as “an output frame frequency”). The signal controller 600 generates output image data with respect to each pixel based on the frequency ratio of the output frame frequency with respect to the input frame frequency, and assigns the output image data to respective different frames.

For example, when the frequency ratio of a frame of output image data (referred to as “an output frame”) with respect to a frame of input image data (referred to as “an input frame”) is 2:3, the signal controller 600 outputs output image data DAT for three frames while input image data R, G, and B for two frames are inputted. The three frames include two normal frames and one additional frame. The output image data DAT for the normal frames have values equal to those of the input image data R, G, and B. The output image data DAT for the additional frame are equal to the input image data R, G, and B or impulsive data. At this time, the impulsive data is data for black color or for low gray. A method for generating the output image data for the additional frame will be described later in detail.

When the frequency ratio is 1:2, the signal controller 600 outputs output image data DAT for two frames, while image data R, G, and B for one frame are inputted. The two frames include one normal frame and one additional frame.

The gate control signals CONT1 include a scanning start signal STV for instructing the gate driver 400 to start scanning and at least one clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of start of data transmission for a group of pixels, a load signal LOAD for instructing the data driver 500 to apply the data voltages to the data lines D₁-Dₘ, and a data clock signal HCLK. The data control signal CONT2 may further include an inversion signal RVS for reversing the polarity of the data voltages (with respect to the common voltage Vcom).

In response to the data control signals CONT2 from the signal controller 600, the data driver 500 receives the output image data DAT for a pixel row from the signal controller 600, converts the output image data DAT into analog data voltages selected from the gray voltages supplied from the gray voltage generator 800, and applies the data voltages to the data lines D1-Dm.

In response to the gate control signals CONT1 from the signal controller 600, the gate driver 400 applies the gate-on voltage Von to the gate line G1-Gn, thereby turning on the switching elements Q connected thereto.

The difference between the data voltage and the common voltage Vcom is represented as a voltage across the LC capacitor C_{LC}, which is referred to as a pixel voltage. The LC molecules in the LC capacitor C_{LC} have orientations depending on the magnitude of the pixel voltage, and the molecular orientations determine the polarization of light passing through the LC layer 3. The polarizer(s) converts the light polarization into light transmittance.

By repeating this procedure by a unit of the horizontal period (which is denoted by “1H” and is equal to one period of the horizontal synchronization signal Hsync and the data enable signal DE), all gate lines G1-Gn are sequentially supplied with the gate-on voltage Von during a frame, thereby applying the data voltages to all pixels. When the next frame starts after finishing one frame, the inversion control signal RVS applied to the data driver 500 is controlled such that the polarity of the data voltages is reversed (which is referred to as “frame inversion”). The inversion control signal RVS may also be controlled such that the polarity of the data voltages flowing in a data line in one frame is reversed (for example, line inversion and dot inversion), or the polarity of the data voltages in one packet is reversed (for example, column inversion and dot inversion).

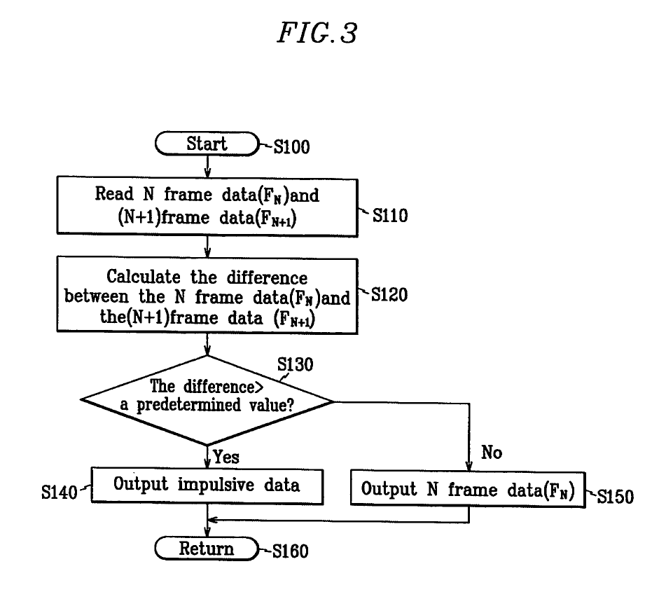

Next, a method for generating output image data for an additional frame in the signal controller of an LCD according to an embodiment of the present invention will be described in detail with reference to FIG. 3.

FIG. 3 is a flow chart illustrating a method for generating output image data of an additional frame in an LCD according to an embodiment of the present invention.

For convenience of explanation, input image data for the N_th input frame is referred to as N frame data F_{N}.

The data processor 610 stores the input image data R, G, and B by a frame unit into the memory 620 through a predetermined data processing procedure when the input image data R, G, and B is inputted. It is assumed that the memory 620 may store two frame data such as N frame data F_{N} and N+1 frame data F_{N+1}.

The data processor 610 sequentially reads the N frame data F_{N} and the N+1 frame data F_{N+1} stored in the memory 620 (S110).

By comparing the N frame data F_{N} with the N+1 frame data F_{N+1} by a pixel unit, the data processor 610 calculates the difference between image data of two frame data (S120) and compares the difference with a predetermined value (S130).

When the difference exceeds the predetermined value (S130), the data processor 610 determines that pixels are to display a motion image in which the difference between the gray of N frame data F_{N} and the gray of N+1 frame data F_{N+1} is larger than a predetermined gray. Thus, the data processor 610 outputs impulsive data (S140).

However, when the difference does not exceed the predetermined value (S130), the data processor 610 determines that pixels are to display a static image in which the difference between the gray of N frame data F_{N} and the gray of N+1 frame data F_{N+1} is smaller than the predetermined gray. Thus, the data processor 610 outputs N frame data F_{N} (S150). When the pixels are for the motion image, the data processor 610 may output the N+1 frame data F_{N+1} or motion compensated data which compensates the N frame data F_{N} or the N+1 frame data F_{N+1} to a predetermined state. Accordingly, the signal controller 600 may further include a processing unit with a motion compensation function.

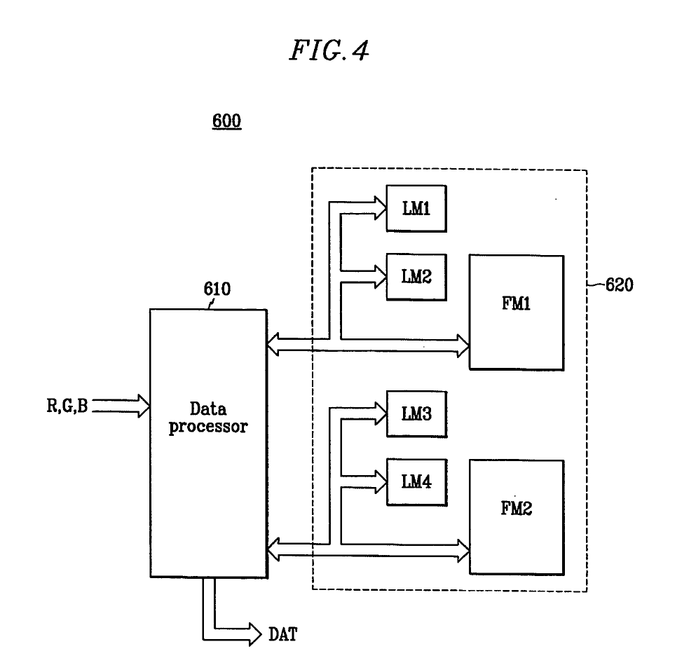

Next, the operation for generating output image data based on a given frequency ratio to output them will be described in detail with reference to FIG. 4.

FIG. 4 is a block diagram of a signal controller of an LCD according to an embodiment of the present invention.

As show in FIG. 4, the signal controller 600 of an LCD according to an embodiment of the present invention includes the data processor 610 and the memory 620 as described above. The memory 620 includes four row memories LM1-LM4 and two frame memories FM1 and FM2.

The frame memories FM1 and FM2 are memories storing image data for one frame and are connected to the data processor 610. The frame memories FM1 and FM2 may be DDR (double data rate) RAMs (random access memory). The DDR RAM may perform read/write operations at both a rising edge and a falling edge of a clock signal applied thereto.

The row memories LM1-LM4 are memories storing image data for one pixel row and may perform read/write operations with a speed equal to that of the frame memories FM1 and FM2. The two row memories LM1 and LM2 among LM1-LM4 are connected to a frame memory FM1 and the data processor 610, and are row memories for writing and reading with respect to the frame memory FM1. The other row memories LM3 and LM4 are connected to a frame memory FM2 and the data processor 610, and are row memories for writing and reading with respect to the frame memory FM2.

The data processor 610 receives the input image data R, G, and B and stores the received input image data R. G, and B into the memories FM1 and FM2 by a frame unit through the row memories LM1-LM4. The data processor 610 generates output image data DAT by using predetermined data processing for output to the data driver 500.

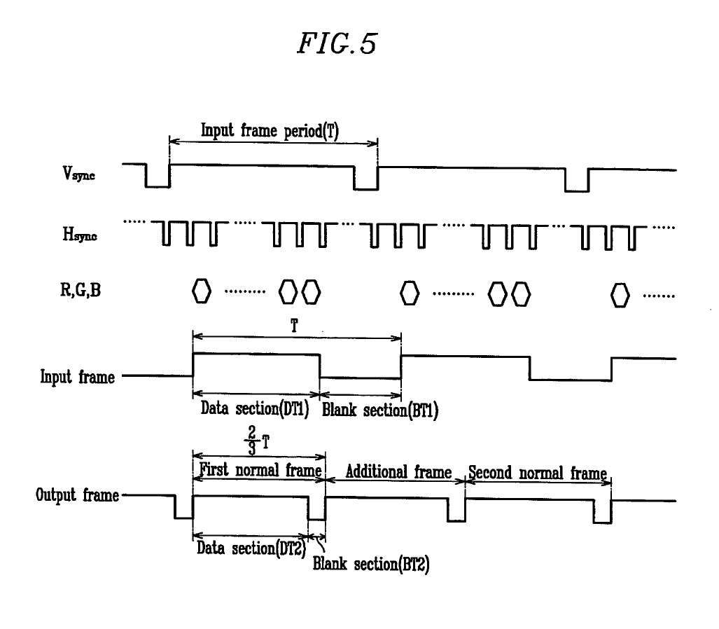

Now, the operation of the signal controller 600 when the frequency ratio is 2:3 will be described in detail with reference to FIGS. 5 to 7.

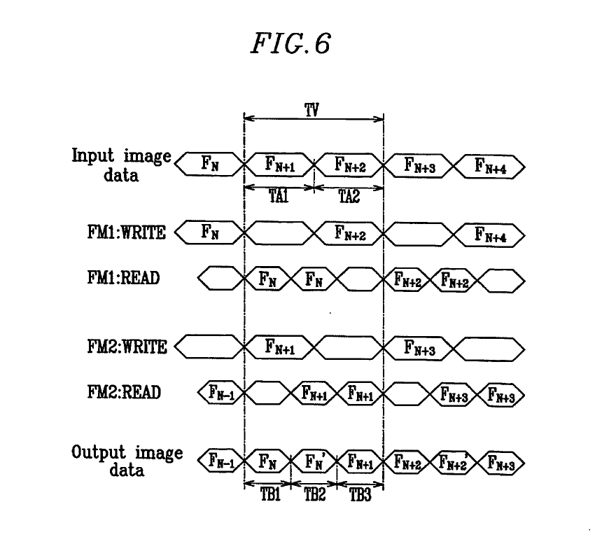

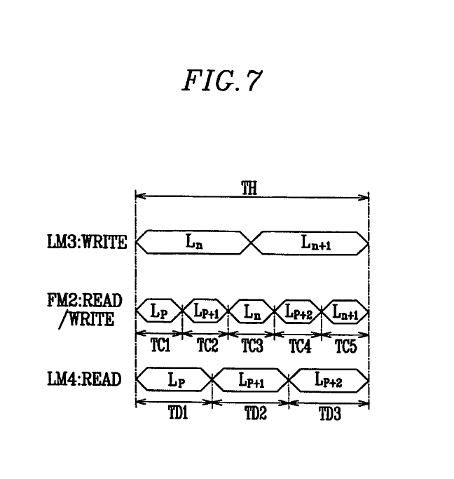

FIG. 5 is a timing diagram of an input frame and an output frame when the frequency ratio thereof is 2:3 in an LCD according to an embodiment of the present invention, and FIG. 6 is a timing diagram representing input image data and output image data by a frame unit when the frequency ratio thereof is 2:3 in an LCD according to an embodiment of the present invention. FIG. 7 is a timing diagram representing the input image data and the output image data shown in FIG. 6 by a pixel row unit.

First, timing of an input frame and an output frame will be described.

As shown in FIG. 5, by being supplied with a vertical synchronization signal Vsync of one input frame period T and a horizontal synchronization signal Hsync, the signal controller 600 sequentially receives input image data R, G, and B corresponding to the 1V synchronizing with the signals Vsync and Hsync. At this time, the one input frame period T is divided into a data application section and a blank section. As shown in FIG. 5, the blank section BT1 is before and after a duration in which the vertical synchronization signal Vsync maintains a low level and the input image data R, G, and B are not applied to the signal controller 600 thereof. Thus, the input image data R, G, and B are substantially applied to the signal controller 600 for the data application section DT1, but are not applied to the signal controller 600 for a duration from an end point of the data application section DT1 to a predetermined point after the next input frame period is started.

When the frequency ratio is 2:3, the output frame period is (2/3)T. That is, the signal controller 600 receives input image data R, G, and B for two frames and outputs output image data DAT for three frames, for two input frame periods 2T. The three output frames include a first normal frame, an additional frame, and a second normal frame in sequence, and are in turn repeated. Each output frame includes a data application section DT2 substantially outputting the output image data DAT and a blank section BT2 not outputting them.

Next, the operation for generating output image data DAT for the three output frames will be described in detail.

For convenience of explanation, as shown in FIG. 6, the operation in a section TV for which the N+1 frame data F_{N+1} and N+2 frame data F_{N+2} are applied will be described. The section TV is divided into two subsections TA1 and TA2 for which the input image data R, G, and B for two frames are applied or three subsections TB1-TB3 for which the output image data DAT for three frames are outputted.

The data processor 610 receives N+1 frame data F_{N+1} and writes the received frame data F_{N+1} into the frame memory FM2, during the subsection TA1, and receives N+2 frame data F_{N+2} and writes the received frame data F_{N+2} into the frame memory FM1, during the subsection TA2.

In the TB1, the data processor 610 sequentially reads the N frame data F_{N} from the frame memory FM1 and outputs the read N frame data F_{N} as output image data for the normal frame to the data driver 500. At this time, the N frame data FM is stored into the frame memory FM1 in a previous input frame period T.

In the TB2, the data processor 610 sequentially reads the N frame data F_{N} and the N+1 frame data F_{N+1} from the frame memories FM1 and FM2, respectively. Next, the data processor 610 compares the read frame data F_{N} and F_{N+1} with each other and outputs the impulsive data or the frame data F_{N} as output image data F_{N}′ for the additional frame to the data driver 500, based on the comparison result.

In the subsection TB3, the data processor 610 again reads the N+1 frame data F_{N+1} from the frame memory FM2 and outputs the read frame data F_{N+1} as output image data for a second normal frame to the data driver 500.

The operation of the above-described signal controller 600 is repeated by 2 input frame periods 2T, and thereby the signal controller 600 generates output image data DAT for each output frame.

Meanwhile, the write operation and the read operation with respect to frame memories FM1 and FM2 overlap during a section of the TB2. The operation of only the frame memory FM1 will be described since the operations of the frame memories FM1 and FM2 are substantially equal to each other in the overlapped section.

For convenience of explanation, data for the n_th pixel row is called n row data Ln, and as shown in FIG. 7, the operation during a section TH for which n row data Ln and (n+1) row data Ln+1 among the (N+1) frame data F_{N+1} are externally applied will be described. The section TH is divided into five subsections TC1-TC5, each section having a (2/5)H period and three subsections TD1-TD3. At this time, the row data is a 1H period.

The data processor 610 receives n row data Ln and (n+1) row data Ln+1 and writes the received data Ln and Ln+1 into the row memory LM3, during the section TH, and reads row data Ln and Ln+1 from the row memory LM3 and writes the received row data Ln and Ln+1 into the frame memory FM2 during the subsections TC3 and TC5, respectively.

In addition, the data processor 610 reads p row data Lp, (p+1) row data Lp+1, and (p+²) row data Lp+2 from the frame memory FM2 during the subsections TC1, TC2, and TC4, respectively and writes the read data Lp, Lp+1, and Lp+2 into the row memory LM4. The row data Lp, Lp+1, and Lp+2 is already stored into the frame memory FM2.

Next, the data processor 610 reads the row data Lp, Lp+1, and Lp+2 from the row memory LM4 for each subsection TD1-TD3 to use for generating the output image data for the additional frame.

At this time, the speeds of the clock signals applied to the frame memories FM1 and FM2 (referred to as “clock speeds”) may be defined as below. The frame memories FM1 and FM2 have to read or write five row data when the two row data are inputted thereto. Moreover, the frame memories FM1 and FM2 may subject the write or read operations at a rising edge and a falling edge of the clock signals. Thus, if a frequency of the input image data R, G, and B is “A”, the clock speeds of the clock signals are defined as A×5/(2/0.5). As an example, when a resolution of an LCD is WXGA (wide extended graphics array), the frequency of the input image data R, G, and B is about 75 MHz, and thereby the clock speeds of the clock signals are defined as about 93.75 MHz.

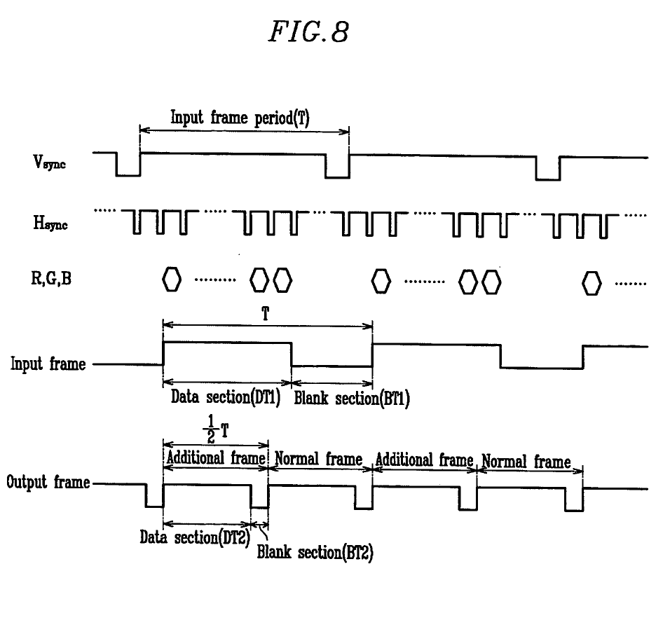

Next, for the frequency ratio of 1:2, the operation of the signal controller 600 will be described in detail with reference to FIGS. 8 to 10.

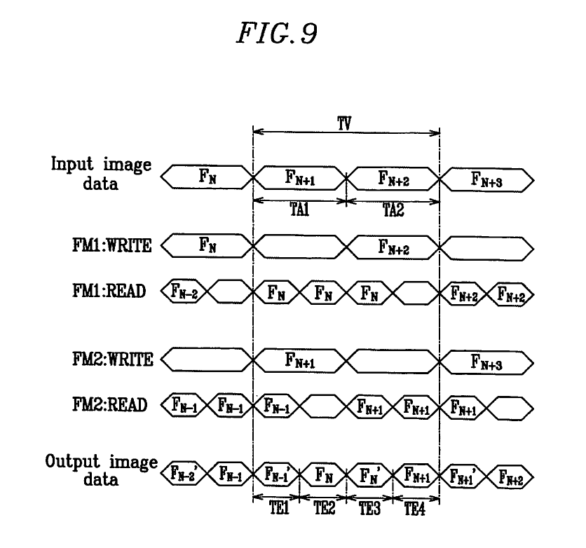

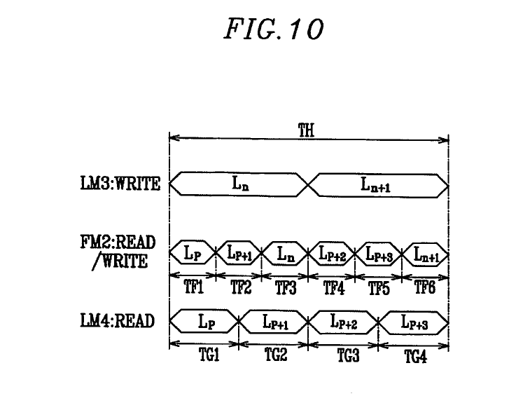

FIG. 8 is a timing diagram of an input frame and an output frame when the frequency ratio thereof is 2:3 in an LCD according to an embodiment of the present invention. FIG. 9 is a timing diagram of an input frame and an output frame by a frame unit when the frequency ratio thereof is 1:2 in an LCD according to an embodiment of the present invention. FIG. 10 is a timing diagram representing the input image data and the output image data shown in FIG. 9 by a pixel row unit.

First, the timing of an input frame and an output frame will be described. When the frequency ratio is 1:2, the timing of the input frame is equal to that when the frequency ratio is 2:3, and a detailed description thereof is omitted.

As shown in FIG. 8, since the frequency ratio is 1:2, a period of the output frame is (1/2)T. That is, the signal controller 600 receives input image data R, G, and B for one frame and outputs output image data DAT for two frames, for one input frame period T. The two output frames include an additional frame and a normal frame in sequence, and are in turn repeated. Each output frame includes a data application section DT2 substantially outputting the output image data DAT and a blank section BT2 not outputting them.

Next, the operation for generating the two output frames will be described in detail.

As shown in FIG. 9, the operation in a section TV for which the N+1 frame data F_{N+1} and N+2 frame data F_{N+2} are applied will be described. The section TV is divided into two subsections TA1 and TA2 or four subsections TE1-TE4 The data processor 610 receives N+1 frame data F_{N+1} and writes the received frame data F_{N+1} into the frame memory FM2 during the subsection TA1, and receives N+2 frame data F_{N+2} and writes the received frame data F_{N+2} into the frame memory FM1 during the subsection TA2.

In the subsection TE1, the data processor 610 sequentially reads the N frame data F_{N} and N−1 frame data F_{N-1} from the frame memories FM1 and FM2, respectively. Next, the data processor 610 compares the read frame data F_{N} and F_{N-1} and outputs the impulsive data or the frame data F_{N-1} as output image data F_{N-1}′ for the additional frame to the data driver 500, based on the comparison result. At this time, the frame data F_{N} and F_{N-1} is already stored into the frame memory FM1.

In the section TE2, the data processor 610 again reads the N frame data F_{N} from the frame memory FM1 and outputs the read frame data F_{N} as output image data for the normal frame to the data driver 500.

In the subsection TE3, the data processor 610 sequentially reads the N frame data F_{N} and N+1 frame data F_{N+1} from the frame memories FM1 and FM2, respectively. Next, the data processor 610 compares the read frame data F_{N} and F_{N+1} and outputs the impulsive data or the N frame data F_{N} as output image data F_{N}′ for the additional frame to the data driver 500, based on the comparison result.

In the subsection TE4, the data processor 610 again reads the N+1 frame data F_{N+1} from the frame memory FM2 and outputs the read frame data F_{N+1} as output image data for the normal frame to the data driver 500.

The operation of the above-described signal controller 600 is repeated by 2 input frame periods 2T, and thereby the signal controller 600 generates output image data DAT for the output frame.

Meanwhile, the write operation and the read operation with respect to frame memories FM1 and FM2 overlap for a section of each of the subsections TE1 and TE3. Since the operations of the frame memories FM1 and FM2 are substantially equal to each other in the overlapped section, the operation of only the frame memory FM2 will be described

As shown in FIG. 10, the operation during a section TH for which n row data Ln and (n+1) row data Ln+1 among the (N+1) frame data F_{N+1} are externally applied will described. The section TH is divided into six subsections TF1-TF6, each section having a (1/3)H period, or four subsections TG1-TG4, each section having a (1/2)H period. At this time, the row data is a 1H period.

The data processor 610 receives n row data Ln and (n+1) row data Ln+1 and writes the received data Ln and Ln+1 into the row memory LM3 during the section TH, and reads row data Ln and Ln+1 from the row memory LM3 and writes the received row data Ln and Ln+1 into the frame memory FM2 during the sections TF3 and TF6, respectively.

In addition, the data processor 610 reads p row data Lp, (p+1) row data Lp+1, (p+2) row data Lp+2, and (p+3) row data Lp+3 from the frame memory FM2 during the sections TF1, TF2, TF4, and TF5, respectively, and writes the read data Lp, Lp+1, Lp+2, Lp+3 into the row memory LM4. The row data Lp, Lp+1, Lp+2, and Lp+3 is N-1 frame data F_{N-1}, and is already stored into the frame memory FM2.

Next, the data processor 610 reads the row data Lp, Lp+1, Lp+2 and Lp+3 from the row memory LM4 during each subsection TG1-TG4 to use for generating the output image data for the additional frame.

At this time, the speeds of the clock signals applied to the frame memories FM1 and FM2 may be defined as below. The frame memories FM1 and FM2 have to read or write six row data when the two row data are inputted thereto. Moreover, the frame memories FM1 and FM2 may subject the write or read operations at a rising edge and a falling edge of the clock signals. Thus, if a frequency of the input image data R, G, and B is “A”, the clock speeds of the clock signals are defined as A×6/(2/0.5). As an example, when a resolution of an LCD is WXGA (wide extended graphics array), the frequency of the input image data R, G, and B is about 75 MHz, and thereby the clock speeds of the clock signals are defined as about 112.5 MHz.

Meanwhile, if the frequency of the input frame is about 60 Hz, for example, the frequency of the output frame is about 90 Hz since the frequency ratio is 2:3, and the frequency of the output frame is about 120 Hz since the frequency ratio is 1:2.

According to the present invention, by displaying grays of a previous frame or by inserting an additional frame for displaying impulsive data between normal frames, based on the gray difference between the previous frame and the next frame with respect to each pixel, the blurring of an image is prevented, and thereby a total luminance decrease of a screen is also prevented.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A liquid crystal display (LCD) comprising:
a plurality of pixels;
a signal controller outputting externally applied input image data or impulsive data as output image data, based on the input image data; and
a data driver applying data voltages corresponding to the output image data from the signal controller to the pixels,
wherein a frame frequency (referred to as “an input frame frequency”) of a frame (referred to as “an input frame”) of the input image data is different from a frame frequency (referred to as “an output frame frequency”) of a frame (referred to as “an output frame”) of the output image data.

2. The LCD of claim 1, wherein the output frame comprises a normal frame and an additional frame, the output image data for the normal frame is equal to the input image data, and the output image data for the additional frame is equal to one of the input image data and the impulsive data.

3. The LCD of claim 2, wherein the input image data comprises first and second frame data, and
the signal controller outputs the impulsive data when the difference between the first frame data and the second frame data exceeds a predetermined value and outputs the first frame data when the difference does not exceed the predetermined value.

4. The LCD of claim 3, wherein a frequency ratio of the input frame and the output frame is 2:3.

5. The LCD of claim 4, wherein the output frame includes three successive output frames and the three output frames comprise two normal frames and one additional frame.

6. The LCD of claim 3, wherein a frequency ratio of the input frame and the output frame is 1:2.

7. The LCD of claim 6, wherein the output frame includes two successive output frames and the two output frames comprise one normal frame and one additional frame.

8. The LCD of claim 4, wherein the frequency of the input frame is 60 Hz.

9. The LCD of claim 3, wherein the impulsive data have grays that are smaller than a predetermined gray.

10. The LCD of claim 3, wherein the impulsive data is data for a black color.

11. The LCD of claim 3, wherein the signal controller comprises first and second memories for storing the first and second frame data, respectively.

12. The LCD of claim 11, wherein the signal controller writes data for two pixel rows into the first and second frame memories and reads data for three pixel rows from the first and second frame memories, for two horizontal periods.

13. The LCD of claim 11, wherein the signal controller writes data for two pixel rows into the first and second frame memories and reads data for four pixel rows from the first and second frame memories, for two horizontal periods.

14. The LCD of claim 11, wherein the first and second frame memories are DDR (double data rate) RAMs (random access memory).

15. A driving method of a liquid crystal display including a plurality of pixels, the method comprising:
outputting input image data or impulsive data as output image data, based on the input image data; and
applying data voltages corresponding to the output image data to the pixels,
wherein a frame frequency (referred to as “an input frame frequency”) of a frame (referred to as “an input frame”) of the input image data is different from a frame frequency (referred to as “an output frame frequency”) of a frame (referred to as “an output frame”) of the output image data.

16. The method of claim 15, wherein the output frame comprises a normal frame and an additional frame, the output image data for the normal frame is equal to the input image data, and the output image data for the additional frame is equal to one of the input image data and the impulsive data.

17. The method of claim 16, wherein the input image data comprises first and second frame data, and
the outputting of the input image data or the impulsive data comprises:
calculating the difference between the first frame data and the second frame data;
comparing the difference with a predetermined value; and
outputting the impulsive data as the input image data when the difference exceeds the predetermined value and outputting the first frame data as the input image data when the difference does not exceed the predetermined value.

18. The method of claim 17, wherein the impulsive data have grays that are smaller than a predetermined gray.

19. The method of claim 17, wherein a frequency ratio of the input frame and the output frame is one of 2:3 and 1:2.

20. The method of claim 19, wherein the frequency of the input frame is 60 Hz.
